(19) United States
(12) Patent Application Publication
(10) Pub. No.: US 2015/0363472 A1
(43) Pub. Date: Dec. 17, 2015

(54) COMPUTER SYSTEM AND METHOD FOR ANALYZING DATA

(71) Applicant: Siemens Aktiengesellschaft, Muenchen (DE)

(72) Inventor: Thomas Blum, Neunkirchen A. Br. (DE)

(73) Assignee: SIEMENS AKTIENGESELLSCHAFT, Muenchen (DE)

(21) Appl. No.: 14/736,728

(22) Filed: Jun. 11, 2015

(30) Foreign Application Priority Data
Jun. 11, 2014 (DE) 102014211140.4

(51) Int. Cl. G06F 17/30; H04L 29/08

(52) U.S. Cl. CPC G06F 17/30539; G06F 17/30477; H04L 67/10; G06F 17/30864

(57) ABSTRACT

A computer system for analyzing data has a local computer network for storing raw data, that includes a local data mining unit for generating local analysis data by a statistical analysis based on the raw data. The computer system also has a central computer network for receiving the local analysis data from the local computer network, that includes a central data mining unit for generating central analysis data by a statistical analysis based on the local analysis data.

### BACKGROUND OF THE INVENTION

1. Field of the Invention

The present invention relates to a computer system for analyzing data, and to a method for analyzing data.

2. Description of the Prior Art

The statistical analysis of data, also known as “data mining”, has gained ever greater importance in recent years in all areas of information technology. In the medical field, it is often the goal to analyze the available data in order to generate a benefit for the patient therefrom, for example, an improved, rapid diagnosis. In addition, by the statistical analysis, valuable information can be obtained for a physician with responsibility or a hospital organization, such as the development of optimized examination methods. A manufacturer of the medical devices can use this information in order to offer a predictive device service.

A problem in statistical analysis is the availability of data. Particularly in the medical field, patient-related data are sensitive and require particular protection against misuse. Non-patent-related data, for example system use data or examination times, have a high degree of sensitivity, so that such data should also be protected. As soon as such data leave an internal local computer network, they are subject to incomplete monitoring, so that data security that is required often cannot be assured.

Therefore, many organizations have decided to store and analyze the sensitive data exclusively within their own local computer network. Such declining to share the distribution of raw data, such as patient images, diagnoses or system usage data, leads to restrictions in the statistical data analysis or prevents a statistical data analysis entirely.

The problem of the lack of data security and the lack of preparedness by the user to provide raw data is currently counteracted with the use of contracts, data encryption and data anonymization. Despite these measures, distribution, external storage and analysis of these raw data are still declined by many organizations, just as before.

A further problem of an exclusively centralized analysis of the data is that this is technically complex and large quantities of data are transferred to a central entity. The central entity must also provide large bandwidths and processing resources in order to be able to process the data at all.

### SUMMARY OF THE INVENTION

An object of the invention is to provide a computer system and a method for analyzing data wherein the quantity of data which is transferred between a local computer network and a central computer network is reduced.

According to a first aspect of the invention, the object is achieved by a computer system for analyzing data, having a local computer network for storing raw data, that has a local data mining unit for generating local analysis data by a statistical analysis of the raw data, and a central computer network for receiving the local analysis data from the local computer network. The central computer network has a central data mining unit for generating central analysis data by a statistical analysis based on the local analysis data. This divides the data mining analysis into a local portion and a central portion. By the local statistical analysis, the data quantity of the local analysis data is reduced in comparison with the data quantity of the raw data. The local analysis data can be transferred more rapidly to the central computer network than the raw data. By this approach, the transmission resources are used more efficiently. In addition, data security can be improved by a division of the statistical analysis. In particular, the raw data can be analyzed locally with little technical effort and do not leave the internal local computer network. The central computer network can again further process the local analysis data with little technical effort.

In an embodiment of the computer system, the local computer network has a data store for storing the local analysis data. This allows the local analysis data to be collected and placed in intermediate storage before the local analysis data are transferred to the central computer network.

In a further embodiment of the computer system, the central computer network has a data memory for storing the central analysis data. This allows the central analysis data to be stored for further evaluation.

In a further embodiment of the computer system, the local data mining unit has at least one replaceable data mining procedure or algorithm for carrying out the statistical analysis. This allows the data mining algorithm to be updated and new queries can be adapted. This allows the raw data to be evaluated flexibly.

In a further embodiment of the computer system, the data mining algorithm can be replaced by the central computer network. Thereby, depending on the query, the local analysis data can be acquired during the central data mining.

In a further embodiment of the computer system, the central computer network has an algorithm memory in which a number of data mining algorithms are stored. This allows a number of data mining algorithms to be kept ready and to be transferred, according to requirements, to the local data mining unit.

In a further embodiment of the computer system, the local data mining unit has at least one configurable data mining algorithm for carrying out the statistical analysis. This allows the data mining algorithm to be adapted to different tasks without needing to be again transferred in its entirety. The transfer volume thus can be reduced.

In a further embodiment of the computer system, the data mining algorithm can be configured by the central computer network. This allows the data mining algorithms to be controlled and adapted by the central data mining unit in a technically simple manner.

In a further embodiment of the computer system, the central computer network is configured to transfer the central analysis data to the local computer network. This allows the central analysis data to be further evaluated by the local computer system.

In a further embodiment of the computer system, the local computer network is configured to generate the local analysis data depending on the central analysis data that are transferred. This allows the local data mining to be altered and/or optimized depending on the central analysis data.

According to a second aspect of the invention, the object is achieved by a method for analyzing data, having the steps of storing raw data in a local computer network; generating local analysis data by a statistical analysis of the raw data by a local data mining unit in the local computer network, transferring the local analysis data to a central computer network, and generating central analysis data by a statistical analysis of the local analysis data by a central data mining unit in the central computer network. The same technical advantages are achieved as with the computer system according to the first aspect.

In an embodiment of the method, the method includes the step of replacing a data mining algorithm of the local data mining unit by the central computer network. This achieves the advantage of the data mining algorithm being updated and adapted to new queries. The raw data thus can be evaluated flexibly.

In a further embodiment of the method, the method includes the step of configuring a data mining algorithm of the local data mining unit by the central computer network. This achieves the advantage that the data mining algorithms can also be controlled and adapted by the central data mining unit in a technically simple manner.

In a further embodiment of the method, the method includes the step of transferring the central analysis data to the local computer network. This achieves the advantage that the central analysis data can be further evaluated by the local computer system.

In a further embodiment of the method, the method includes the step of generating the local analysis data depending on the transferred central analysis data. This achieves the technical advantage that the local data mining can be altered and optimized depending on the central analysis data.

In the above description, the solution to the problem has been described primarily in relation to the described system. Features, advantages or alternative embodiments thereof are also applicable to the method, and vice versa. The method and the storage medium described below for carrying out the method can also be further developed with the features that are described in conjunction with the system, and vice versa. The functional features of the method are embodied by suitable device modules, in particular, hardware modules.

The present invention also encompasses a non-transitory, computer-readable data storage medium encoded with programming instructions. The storage medium is loadable in a distributed manner into the above-described local computer network and central computer network, and the programming instructions cause those networks to execute the method in accordance with the invention, as described above.

Within the scope of the invention, not all the steps of the method necessarily have to be executed by the same computer-based entity, but can be carried out on different computer units or entities (e.g. on local and/or central units). It is also possible for individual portions of the above-described method to be implemented in a commercially saleable unit and for the remaining components to be implemented in another saleable unit—effectively, as a distributed system. The sequence of the method steps can also be varied, if required. In the preferred embodiment of the invention, however, initially a local analysis occurs, and subsequently (this can also take place at a later time point) a central analysis is carried out.

### BRIEF DESCRIPTION OF THE DRAWINGS

FIG. 1 is a schematic illustration of a computer system in accordance with the invention.

FIG. 2 is a block diagram of the method in accordance with the invention.

### DESCRIPTION OF THE PREFERRED EMBODIMENTS

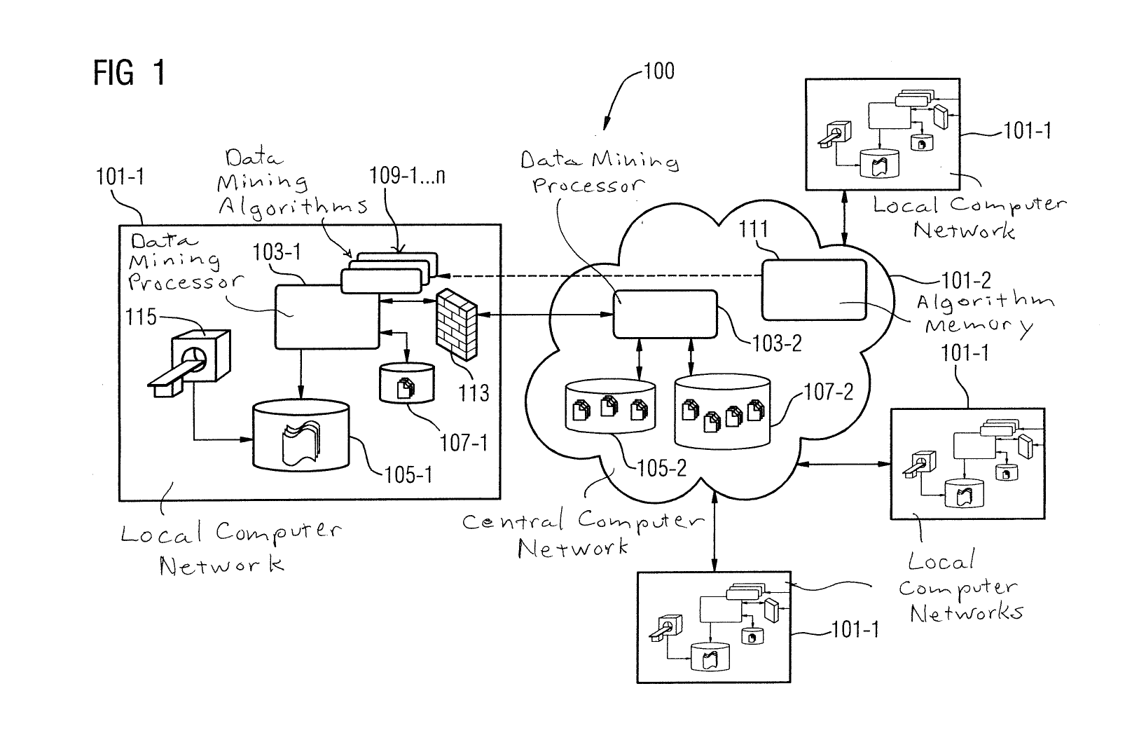

FIG. 1 schematically shows a computer system 100 for analyzing data within a medical environment. The computer system 100 has a number of local computer networks 101-1 in hospitals for the local storage of raw data and a central computer network 101-2 to which the local computer networks 101-1 are connected. The computer networks 101-1 and 101-2 are formed by a combination of different technical, primarily independent computers. The combination of the computers into the computer networks 101-1 and 101-2 can be achieved by different network technologies, for example cable-connected via an Ethernet or LAN connection or wirelessly via a WLAN connection of the individual computers. The computers within the computer networks 101-1 and 101-2 can be networked to one another in different topologies in order to ensure a common data exchange, for example in a ring topology, a star topology, a tree topology or in a meshed topology.

Preferably, the raw data are medical data or health data. The raw data comprise safety-critical data sets or PHI data (protected, or to be protected, personal health data, Protected Health Information). The raw data are input locally, by means of computer terminals 115 or medical devices, into the local computer network 101-1 and comprise, for example, patient data sets, patient images, diagnoses or system operating data. The raw data are stored in an internal data store 105-1 (“internal data store”) of the local computer network 101-1. The local computer network 101-1 is secured by means of a firewall 113. The firewall 113 forms a safety system which protects the local computer network 101-1 against undesirable network access.

The local computer network 101-1 has a local data mining processor 103-1 for generating local analysis data by a statistical analysis based on the stored raw data. The data mining processor 103-1 makes systematic use of statistical methods on the raw data from the internal data store 105-1 with the aim of recognizing new patterns. The extracted local analysis data are collected in a data store 107-1 of the local computer network 101-1 (“local data mining store”) and placed in intermediate storage. The data mining is therefore based on collecting, storing and analyzing the raw data with the aid of statistical analysis algorithms (data mining algorithms).

Subsequently, the local analysis data thus extracted can be transferred to a central computer network 101-2. For this purpose, the central computer network 101-2 has a data store 105-2 for the intermediate storage of the transferred local analysis data (“intermediate results”). In general, the local computer network 101-1 can also have a number of data mining processors 103-1, for example, in order to carry out multi-stage data mining within the local computer network 101-1.

The central computer network 101-2 has a further, central data mining processor 103-2 (“data mining core”) for generating central analysis data by a statistical analysis based on the transferred local analysis data (this can also be designated the first result or the interim result). The central computer network 101-2 is formed, for example, by a data cloud or a computing center. In order to store the central analysis data extracted, the central computer network 101-2 also has a data store 107-2 (“data mining results”).

Through a division of the data mining analysis into a local portion in the local computer network 101-1 and a central portion in the central computer network 101-2, the data security can be improved. The raw data can be analyzed with little technical effort and do not leave the internal local computer network 101-1.

The local data mining processor 103-1 analyzes the raw data with the aid of configurable data mining algorithms 109-1 . . . n, which generate the local analysis data (“intermediate data mining results”, first result or intermediate result). A configuration of the data mining algorithms 109-1 . . . n can be achieved, for example, by a transfer of analysis parameters to the data mining algorithms 109-1 . . . n. The data mining algorithms 109-1 . . . n are formed by computer programs that are capable of, and configured for, automatic specified, independent and/or autonomous execution.

The extracted local analysis data or results are placed in a data store 107-1 (“local data mining store”) of the local computer network 101-1. If only local data mining within the local computer network 101-1 is desired by a user, for example a group of hospitals, these results can only be used directly within the local computer network 101-1.

If, however, a user is interested in profiting from central data mining, the results of the local data mining (“intermediate data mining results”) can be made available by the central computer network 101-2 (“data mining core”).

The advantage of this procedure is that the respective user obtains control over his data, which are made available to the central computer network 101-2 with the central data mining processor 103-2. This is secured by the data mining algorithms 109-1 . . . n which collect and evaluate raw data and only export local analysis data (and therefore only processed raw data). Therefore, no raw data, for example, patient images, diagnoses or system application data are exported, but only the previously locally determined results of a statistical analysis (“local data mining”) based on the raw data.

A further advantage is that local system resources for local data mining can be used, so that lessened system requirements can be placed on the central data mining system (“data mining core”). Between the local computer network 101-1 and the central computer network 101-2, reduced data quantities are transferred.

The computer system 100 can also be used outside the medical domain in any IT environment in which sensitive data are generated and in which evaluations of these data generate added value, for example, in the automotive industry, in manufacturing plants or commercial enterprises.

The creation of local analysis data (“local data mining”) is not restricted to a single evaluation unit within a closed IT environment in the local computer network 101-1, rather it is also conceivable that any subsystem which generates raw data within a closed, local computer network 101-1 of this type evaluates it statistically locally and directly through the use of data mining algorithms 109-1 . . . n and makes it available to the data store 107-1 (“local data mining store”). By this means, a multistage local data mining system with a number of data mining processors 103-1 is realized (multistage “local data mining”). This leads to a further reduction in the necessary system resources for data mining within the closed IT environment within the local computer network 101-1 and enables a decentralized, finely tuned decision as to which data will be used for data mining.

Central analysis data that are generated during central data mining (“data mining core”) using worldwide data can be transferred back to the local data mining (“local data mining”) and used for optimizing the local data mining system.

In general, the data mining of the data mining algorithms 109-1 . . . n is subject to constant change and extension. With each new query determined, for example, by user requests, further evaluations of the raw data can become necessary. With the use of configurable or replaceable data mining algorithms 109-1 . . . n, the local data mining or the central data mining can be dynamically adapted. Since local raw data are analyzed and exported exclusively by the data mining algorithms 109-1 . . . n, simple, seamless monitoring of the data distribution and the data security is ensured. The data mining algorithms 109-1 . . . n in the local computer networks therefore can be configured or replaced by the central computer network 101-2. For this purpose, the central computer network 101-2 has an algorithm memory 111 (“data mining algorithm store”) in which a number of data mining algorithms 109-1 . . . n are stored. Replacement of a data mining algorithm 109-1 . . . n is carried out by transferring a new data mining algorithm 109-1 . . . n from the algorithm memory 111 to the local computer network 101-1 and deactivation or deletion of the old data mining algorithm 109-1 . . . n in the local computer network 101-1.

The central data mining processor 103-2 can be configured or extended by similar mechanisms to the local data mining units 103-1. For example, the data mining algorithms can also be used in the central data mining processor 103-2 for configuration or extension of the data mining functionality of the central computer network 101-2. It is also conceivable thereby to achieve a dynamic relocation of the data mining activities from the local computer network 101-1 to the central computer network 101-2.

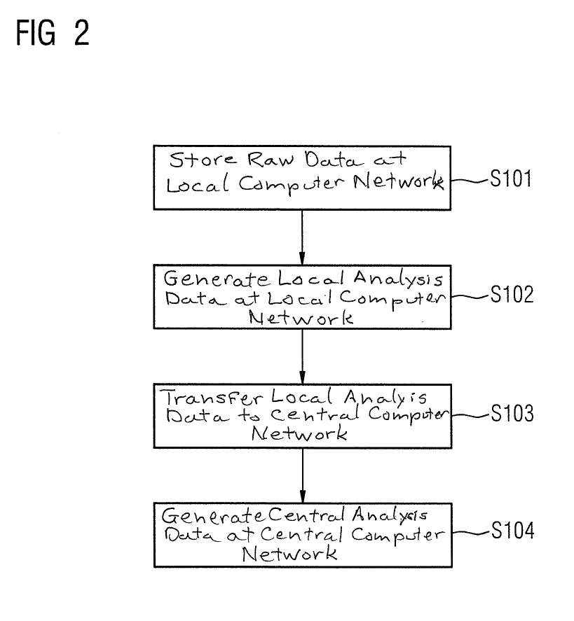

FIG. 2 shows a diagram of a method for analyzing data. The method comprises the steps of storing the raw data (S101) in a local computer network 101-1, generating local analysis data (S102) by a statistical analysis based on the raw data by a local data mining processor 103-1 in the local computer network 101-1, transferring the local analysis data to a central computer network 101-2 (S103) and generating central analysis data by a statistical analysis based on the local analysis data by means of a central data mining unit 103-1 in the central computer network 101-2 (S104).

The data mining is therefore divided into a local (“local data mining”) portion and a central (“data mining core”) portion. By this means, distributed proportional or multi-step data mining results (local/central) are made possible. A user retains control over the data that are exported from the secured IT environment of the local computer network 101-1 and are used for central data mining in the central computer network 101-2.

By the use of local resources for data mining, a high level of reliability and transparency of the exported local analysis data is achieved. This leads to an increase in the trust of the user and to a higher level of acceptance during use. Furthermore, the data quantities to be transferred by means of the network are reduced through local data mining. Aside therefrom, the resources for central data mining (“data mining core”) are lessened.

Since no sensitive patient data or system use data are stored unfiltered in the central computer network 101-2, the effort for data security during central data mining can be reduced. Overall, this enables a more rapid availability of data mining results since the local results of the local data mining can be used directly. Through the use of worldwide data mining results, local data mining is possible without having to export a user's own user-specific data out of the protected IT environment of the local computer network 101-1.

All the features described and shown in conjunction with individual embodiments of the invention can be provided in different combination in the subject matter according to the invention in order simultaneously to realize the advantageous effects thereof. The scope of protection of the present invention is not restricted by the features disclosed in the description or shown in the drawings.

The description of the invention and the exemplary embodiments should not be seen as in any way restrictive with regard to a particular physical realization of the invention. Those skilled in the art will recognize that the invention can be realized partially or entirely in software and/or hardware and/or distributed over a number of physical products, particularly computer program products.

I claim as my invention:

1. A computer system for analyzing data, comprising:
a local computer network configured to store raw data, said local computer network comprising a local data mining processor configured to generate local analysis data by a statistical analysis of said raw data; and
a central computer network in communication with said local computer network, said central computer network being configured to receive the local analysis data from the local computer network, and said central computer network comprising a central data mining processor configured to generate central analysis data by a statistical analysis of said local analysis data.

2. A computer system as claimed in claim 1 wherein said local computer network comprises a data memory in which said local analysis data are stored.

3. A computer system as claimed in claim 1 wherein said central computer network comprises a data memory in which said central analysis data are stored.

4. A computer system as claimed in claim 1 wherein said local data mining unit is configured to operate according to at least one replaceable data mining algorithm to execute said statistical analysis of said raw data.

5. A computer system as claimed in claim 4 wherein said central computer network is configured to replace said data mining algorithm of said local data mining unit.

6. A computer system as claimed in claim 5 wherein said central computer network comprises an algorithm store in which a plurality of data mining algorithms are stored, and wherein said central computer network is configured to select one of the data mining algorithms from said algorithm memory in order to replace the data mining algorithm of said local data mining unit.

7. A computer system as claimed in claim 1 wherein said local data mining unit is configured to execute at least one configurable data mining algorithm to execute said statistical analysis of said raw data.

8. A computer system as claimed in claim 7 wherein said central computer network is configured to configure the configurable data mining algorithm of said local data mining processor.

9. A computer system as claimed in claim 1 wherein said central computer network is configured to transfer the central analysis data to the local computer network.

10. A computer system as claimed in claim 9 wherein said local computer network is configured to perform said statistical analysis of said raw data using the transferred central analysis data.

11. A method for analyzing data, comprising:
storing raw data in a local computer network;
in said local computer network, generating local analysis data by executing a statistical analysis of said raw data in a local data mining processor of said local computer network;
transferring the local analysis data from the local computer network to a central computer network; and
generating central analysis data in said central computer network by executing a statistical analysis based on said local analysis data in a central data mining processor of said central computer network.

12. A method as claimed in claim 11 wherein said local data mining processor performs said statistical analysis according to a replaceable data mining algorithm, and comprising replacing said replaceable data mining algorithm of said local data mining processor with a replacement data mining algorithm provided by said central computer network.

13. A method as claimed in claim 11 wherein said local data mining processor performs said statistical analysis according to a configurable data mining algorithm, and comprising configuring said configurable data mining algorithm from said central computer network.

14. A method as claimed in claim 11 comprising transferring the central analysis data from said central computer network to said local computer network.

15. A method as claimed in claim 14 comprising performing said statistical analysis of said raw data in said local data mining processor dependent on the transferred central analysis data.
